(19) United States
(12) Patent Application Publication
(10) Pub. No.: US 2026/0148491 A1
(43) Pub. Date: May 28, 2026

(54) LEARNING COMPOSITE REPRESENTATIONS OF TEMPORALLY CHANGING SCENES FOR AUTONOMOUS AGENTS

(71) Applicant: NVIDIA Corporation, Santa Clara, CA (US)

(72) Inventors: Yiming Li, Lvliang (CN); Boyi Li, Berkeley, CA (US); Yan Wang, Santa Clara, CA (US); Yue Wang, Los Angels, CA (US); Boris Ivanovic, Mountain View, CA (US); Yurong You, Santa Clara, CA (US); Marco Pavone, Stanford, CA (US)

(21) Appl. No.: 19/322,424

(22) Filed: Sep. 8, 2025

Related U.S. Application Data
(60) Provisional application No. 63/725,446, filed on Nov. 26, 2024.

(51) Int. Cl. G06T 17/00; G06T 11/60

(52) U.S. Cl. CPC G06T 17/00; G06T 11/60

(57) ABSTRACT

Scene reconstruction is a computer vision process that creates a model of a scene from a given input, usually including creating a three-dimensional (3D) scene model from one or more input two-dimensional (2D) images of the scene. High-quality scene reconstruction and rendering is useful for various applications, such as autonomous agent applications and scene editing applications. Existing scene reconstruction methods encounter limitations in dynamic scenes where moving objects are not consistent across views from different times, and these methods generally lack the motion cues essential for effective object-environment decomposition and further lead to incomplete environment reconstruction of novel views from persistent occlusion of environmental structures. The present disclosure integrates spatial memory from prior traversals of a scene when learning a representation of a temporally changing scene, which can provide observations of occluded areas and contextual information for traffic participants for more comprehensive and efficient scene representation learning.

### RELATED APPLICATION(S)

This application claims the benefit of U.S. Provisional Application No. 63/725,446 (Attorney Docket No. NVIDP1427+/24-SC-1622US01), titled “4D GAUSSIAN SPLATTING WITH SPATIAL MEMORY” and filed Nov. 26, 2024, the entire contents of which is incorporated herein by reference.

### TECHNICAL FIELD

The present disclosure relates to computer processes for scene reconstruction.

### BACKGROUND

Scene reconstruction is a computer vision process that creates a model of a scene from a given input, usually including creating as three-dimensional (3D) scene model from one or more input two-dimensional (2D) images of the scene. High-quality scene reconstruction and rendering is useful for autonomous agent applications, such as autonomous vehicle and robotics applications. For example, reconstructed scenes can be used by autonomous agents for understanding and navigating complex and ever-changing environments.

Recent breakthroughs in radiance fields, such as neural radiance fields (NeRF) and 3D Gaussian Splatting (3DGS)—have revolutionized scene reconstruction and rendering through differentiable 3D scene representations. Despite superior performance in static scenes, they encounter limitations in dynamic urban scenes as moving objects are not consistent across views from different times, resulting in rendering artifacts. Previous efforts address dynamic objects through 3D bounding box annotations. However, reliance on costly 3D labeling limits their efficiency and scalability.

To eliminate the need for 3D labeling, recent work takes as input LiDAR and camera sensory data and leverages motion as a self-supervision signal to disentangle dynamic components from static backgrounds. However, transient objects like parked cars are static—just like the environment—and therefore lack the motion cues essential for effective object-environment decomposition. Additionally, their persistent occlusion of environmental structures leads to incomplete environment reconstruction of novel views. Therefore, learning a complete and disentangled composite representation for complex urban scenes via self-supervision remains a significant challenge.

There is thus a need for addressing these issues and/or other issues associated with the prior art. For example, there is a need to integrate spatial memory from prior traversals of a scene when learning a representation of a temporally changing scene, which can provide additional cues such as observations of occluded areas and contextual information for traffic participants for more comprehensive and efficient scene representation learning.

### SUMMARY

A method, computer readable medium, and system are disclosed for generating a 3D representation of the real-world scene. At least one first image capturing a real-world scene at a first point in time is accessed. A representation of time-invariant components of the real-world scene is accessed, where the representation of time-invariant components of the real-world scene is generated from one or more second images capturing the real-world scene at one or more second points in time that occurred earlier than the first point in time. A 3D representation of the real-world scene at the first point in time is generated using the at least one first image and the representation of the time-invariant components of the real-world scene.

### BRIEF DESCRIPTION OF THE DRAWINGS

FIG. 1 illustrates a method for generating a 3D representation of the real-world scene, in accordance with an embodiment.

FIG. 2 illustrates a system pipeline for supervised learning of a 3D representation of a real-world scene, in accordance with an embodiment.

FIG. 3 illustrates an implementation of the system pipeline of FIG. 2, in accordance with an embodiment.

FIG. 4 illustrates a method for using a 3D representation of a real-world scene for scene editing, in accordance with an embodiment.

FIG. 5 illustrates exemplary inputs and outputs of the method of FIG. 4, in accordance with an embodiment.

FIG. 6A illustrates inference and/or training logic, according to at least one embodiment;

FIG. 6B illustrates inference and/or training logic, according to at least one embodiment;

FIG. 7 illustrates training and deployment of a neural network, according to at least one embodiment;

FIG. 8 illustrates an example data center system, according to at least one embodiment.

### DETAILED DESCRIPTION

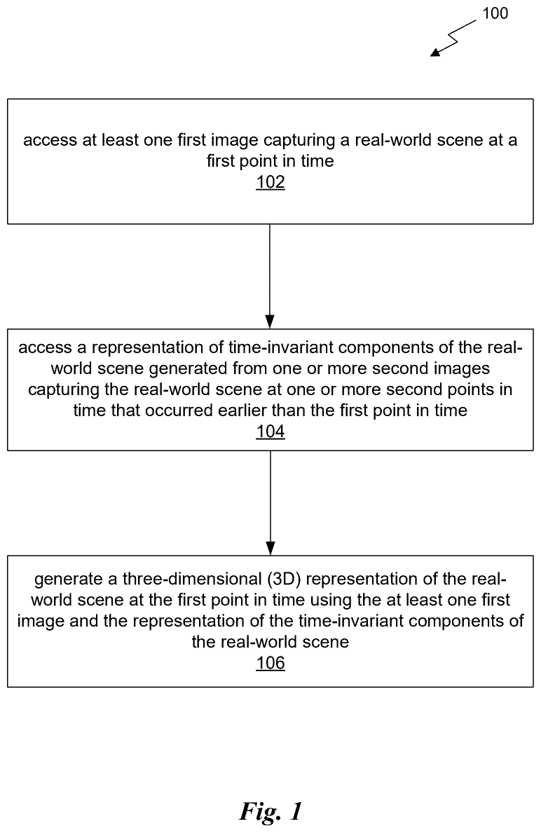

FIG. 1 illustrates a method 100 for generating a 3D representation of the real-world scene, in accordance with an embodiment. The method 100 may be performed by a device, which may comprise of a processing unit, a program, custom circuitry, or a combination thereof, in an embodiment. In another embodiment a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

In operation 102, at least one first image capturing a real-world scene at a first point in time is accessed. The real-world scene refers to a temporally changing environment encountered in real-life. In an embodiment, each first image may capture the real-world scene from a different viewpoint at the (same or near-same) first point in time.

In an embodiment, the at least one first image may include at least one frame of a video capturing the real-world scene at the first point in time. In an embodiment, the at least one first image may be generated by a camera. In an embodiment, the camera may be installed on an autonomous driving vehicle traversing the real-world scene. In an embodiment, the camera may be installed on a drone traversing the real-world scene.

In operation 104, a representation of time-invariant components of the real-world scene is accessed, where the representation of time-invariant components of the real-world scene is generated from one or more second images capturing the real-world scene at one or more second points in time that occurred earlier than the first point in time. The time-invariant components of the real-world scene refer to components of the real-world scene that are unchanged over two or more points in time. In an embodiment, the time-invariant components of the real-world scene may include (e.g. be restricted to) static (e.g. stationary) objects in the real-world scene, such as buildings in an urban environment.

The representation of the time-invariant components refers to a representation generated from the one or more second images capturing the real-world scene at one or more points in time that occurred prior to the first point in time when the at least one first image captured the real-world scene. In an embodiment, the representation of the time-invariant components of the real-world scene may exclude transient components of the real-world scene. Transient components refer to components of the real-world scene that are changed or relocated over two or more points in time. In an embodiment, the transient components of the real-world scene may include (e.g. be restricted to) dynamic (e.g. moving) objects in the real-world scene, such as moving humans, moving vehicles, etc.

In an embodiment, a spatial memory may include the representation of the time-invariant components of the real-world scene. In an embodiment, the representation of the time-invariant components of the real-world scene may include 3D Gaussians of the time-invariant components of the real-world scene. In an embodiment, the 3D Gaussians may be learned using 3D Gaussian Splatting (3DGS).

In an embodiment, the one or more second images may include one or more second frames of one or more videos capturing the real-world scene at the one or more second points in time that occurred earlier than the first point in time. In an embodiment, the one or more second images may be generated by the same camera that captured the at least one first image. In another embodiment, the one or more second images may be generated by a camera different from the one that captured the at least one first image. In embodiments, the one or more second images may capture the same or different viewpoint(s) of the real-world scene as at least one first image.

In operation 106, a 3D representation of the real-world scene at the first point in time is generated using the at least one first image and the representation of the time-invariant components of the real-world scene. The 3D representation of the real-world scene refers to a representation of the real-world scene that defines in 3D at least the time-invariant components of the real-world scene. The 3D representation of the real-world scene may define the time-invariant components of the real-world scene based on their depiction in both the at least one first image and the representation of the time-invariant components of the real-world scene generated from the one or more second images.

In an embodiment, the 3D representation of the real-world scene may also define the transient components of the real-world scene. The 3D representation of the real-world scene may define the transient components of the real-world scene based on their depiction in the at least one first image. In an embodiment, the transient components of the real-world scene at the first point in time may be detected from the at least one first image and a representation of the transient components of the real-world scene at the first point in time may be generated. The transient components of the real-world scene at the first point in time may be detected based on a depth difference between the at least one first image and the representation of the time-invariant components of the real-world scene, and a color difference between the at least one first image and the representation of the time-invariant components of the real-world scene. The representation of the transient components of the real-world scene may include 4D Gaussians of the transient components of the real-world scene, for example.

Further to this embodiment, the 3D representation of the real-world scene at the first point in time may be generated based on the representation of the transient components of the real-world scene and the representation of the time-invariant components of the real-world scene. Thus, for example, the 3D representation of the real-world scene at the first point in time may include both the time-invariant components of the real-world scene and the transient components of the real-world scene. In an embodiment, the representation of the transient components of the real-world scene and the representation of the time-invariant components of the real-world scene may be optimized (i.e. for use in generating the 3D representation of the real-world scene) by minimizing at least one loss function. Accordingly, the 3D representation of the real-world scene may be comprised of the optimized representation of the transient components of the real-world scene and the optimized representation of the time-invariant components of the real-world scene.

In an embodiment, the at least one loss function may be a regularization loss function that promotes disentanglement of the representation of the transient components of the real-world scene and the representation of the time-invariant components of the real-world scene. In an embodiment, the at least one loss function may be a maintenance loss function that supervises occluded pixels in the representation of the time-invariant components of the real-world scene to preserve the structure of one or more of the time-invariant components that are obscured by one or more of the transient components. In an embodiment, the at least one loss function may be a rendering loss function. In an embodiment, the at least one loss function may be a depth smoothness loss function.

To this end, the method 100, when performed by a device, generates a 3D representation of a real-world scene as it exists at a first point in time from both one or more images of the scene captured at the first point in time and one or more images of the scene captured at one or more prior points in time. Use of the images of the scene captured at the one or more prior points in time enables the 3D representation to define features of the scene that may otherwise be occluded or unobservable in the one or more images of the scene captured at the first point in time. The method 100, when used for scene reconstruction, particularly improves the 3D representation result for temporally changing scenes.

In an embodiment, the method 100 may further include outputting the 3D representation of the real-world scene to a downstream task. In an embodiment, the downstream task may include an image synthesis or image editing application. For example, the downstream task may use the 3D representation of the real-world scene to perform image synthesis or image editing, including removing at least one object (time-invariant or transient component) in the at least one first image of the real-world scene, relocating at least one object (time-invariant or transient component) in the at least one first image of the real-world scene, and/or transporting at least one object (time-invariant or transient component) from the one or more second images to the at least one first image of the real-world scene.

In an embodiment, the downstream task may include an autonomous agent application, such as an autonomous vehicle application or robotic application. For example, the downstream task may use the 3D representation of the real-world scene to control an autonomous agent. Just by way of example, the downstream task may process the 3D representation of the real-world scene to make decisions regarding traversal the real-world scene by the autonomous agent. In various embodiments, the method 100 may be performed by a hardware and/or software of the autonomous agent or by a hardware and/or software remotely located from the autonomous agent (e.g. such as hardware and/or software located in the cloud).

In one exemplary implementation of the method 100, a 3D representation of a real-world scene is generated from at least one first image capturing the real-world scene at a first point in time, and a representation of time-invariant components of the real-world scene generated from one or more second images capturing the real-world scene at one or more second points in time that occurred earlier than the first point in time. The at least one first image is then edited using the 3D representation of the real-world scene to form at least one edited image, the editing including at least one of: removing at least one object in the at least one first image of the real-world scene, relocating at least one object in the at least one first image of the real-world scene, or transporting at least one object from the one or more second images to the at least one first image of the real-world scene. Further, the at least one edited image is output.

Further embodiments will now be provided in the description of the subsequent figures. It should be noted that the embodiments disclosed herein with reference to the method 100 of FIG. 1 may apply to and/or be used in combination with any of the embodiments of the remaining figures below.

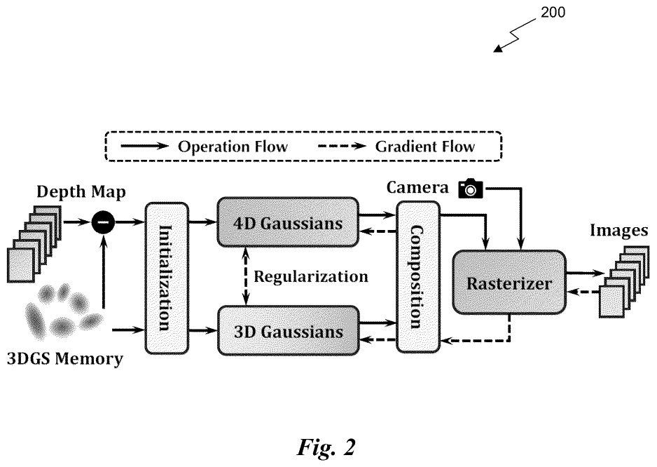

FIG. 2 illustrates a system pipeline 200 for supervised learning of a 3D representation of a real-world scene, in accordance with an embodiment. The system pipeline 200 may be implemented to carry out the method 100 of FIG. 1, in an embodiment. Thus, the definitions and descriptions provided above may equally apply to the present embodiment.

Learning a spatiotemporal representation of an ever-changing (e.g. urban) scene, for example with an autonomous agent, is non-trivial because of sparse observations, complex compositions, unconstrained dynamics, and varying illuminations. In contrast to previous efforts requiring human annotations or LiDARs, system pipeline 200 provides a self-supervised and camera-only paradigm. The learned representations aim for (1) comprehensiveness, holistically capturing all elements of the scene—including dynamic objects, static obstacles, and permanent road infrastructures; and (2) granularity, enabling the precise tracking of each instance over time. Hence, the system pipeline 200 enables holistic reconstruction, composite rendering, and editable simulation while reducing the need for costly annotations and high-end sensors.

The system pipeline 200 divides the scene into environment and object fields. The environment field is represented by 3D Gaussian Splats, capturing permanent structures such as buildings and roads, while the object field uses 4D Gaussian Splats, incorporating an additional dimension to model the probable motion dynamics of transient objects. Specifically, the system pipeline 200 first runs a warm-up stage to build spatial memory represented by 3D Gaussian Splats from multiple past traversals, primarily capturing permanent scene structures such as road infrastructures. It then employs the memory for initialization of the current traversal, which is different from the original 3DGS initialized by Structure-from-Motion (SfM) points. Afterwards, the system pipeline 200 adapts the environment field to account for the appearance changes while creating an object field to model previously unseen instances which could be either dynamic or static. Such adaptation of the environment and object discovery emerge simply by minimizing an red-green-blue (RGB) rendering loss plus a regularization loss between two fields, thus being purely self-supervised.

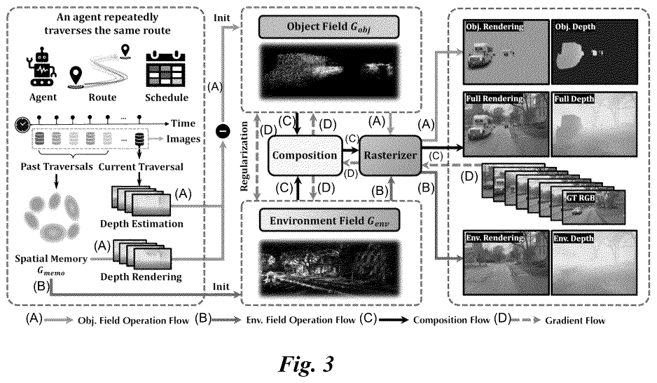

FIG. 3 illustrates an implementation of the system pipeline of FIG. 2, in accordance with an embodiment.

In the present implementation, an autonomous agent, such as a self-driving vehicle, repeatedly traverses a route, capturing images of the same route at different times. The collected images are temporally continuous within the traversal but temporally disconnected between traversals. The time interval between consecutive traversals depends on how frequently the agent revisits the location and varies randomly, ranging from several hours to days. Through repeated navigation, the agent can filter out the time-varying signals across traversals and build a spatial memory capturing the time-invariant components. Afterwards, the agent can leverage spatial memory as a basis to learn composite scene representations in the subsequent traversals.

### Composite Gaussian Splatting

The scene is divided into two fields: the environment field, which corresponds to the time-invariant component (permanent structures), and the object field, which represents the time-varying component (transient entities). The object field features both dynamic and static-yet transient objects.

Environment Field. The environment field denoted by Gₑₙᵥ is a set of 3D Gaussians with attributes (μ, S, R, o, c) where μ∈ [symbol] is the mean of Gaussian, S∈ [symbol] is the scaling coefficient, R∈ [symbol] is the rotation quaternion, o∈ [symbol] is the opacity and c∈ [symbol] is the d-dimensional feature. Mean μ is linked to the position of the Gaussian point in the 3D world, while S, R influence the shape of the Gaussian. Opacity o determines the visibility of the Gaussian, and c contains spherical harmonic coefficients and possibly self-supervised feature descriptors.

Object field. Transient entities in a single traversal can be either dynamic or static. The object field, denoted by G_{obj}, additionally assigns dynamic properties to each Gaussian, including (t₀, τ, v, a), where t₀∈ [symbol] and τ∈ [symbol] represent the peak time and lifespan, respectively. The opacity of a Gaussian is defined as

$$o ( t ) = o \cdot exp ( - \frac{{( t - {t}_{0} )}^{2}}{2 {τ}^{2}} ) .$$

The vectors v and a denote velocity and acceleration, respectively, such that at time t, the position of the corresponding Gaussian is given by

$$x ( t ) = μ + {v}_{0} ( t - {t}_{0} ) + \frac{1}{2} {a ( t - {t}_{0} )}^{2} .$$

By combining different segments of simple uniformly accelerated linear motion, this parametrization can approximate complex non-uniform motion.

### Initialization

Environment field initialization. Given RGB images from multiple previous traversals, a general-purpose SfM pipeline (e.g. COLMAP) is leveraged to jointly reconstruct sparse points and calculate the camera poses. A differential rendering pipeline, such as 3DGS, is then used to learn the positions, rotations, scales, opacities, and features of the 3D Gaussians. Since transient objects typically appear in only one traversal or a few frames and occupy a small proportion of the scene, they are automatically bypassed to a certain extent in the 3D representation. To further purify the 3D environmental representation, self-supervised mapping methods are employed to remove these transient objects during optimization. Subsequently, the learned Gaussians from previous traversals form the spatial memory, denoted as Gₘₑₘₒ, which is used to initialize Gₑₙᵥ.

Object field initialization. Given RGB images in a new traversal, the SfM pipeline is employed to perform incremental registration, which integrates new images into the previously reconstructed scene to obtain camera poses for the newly captured data. Next, significant changes in the scene are identified—indicating emerging objects in the latest traversal—by leveraging two types of inconsistencies. The first is geometry inconsistency: a pretrained depth model (e.g. DepthAnything) is used to estimate a depth map for each image in the current traversal. The depth map is then rendered using the spatial memory, Gₘₑₘₒ, and the depth difference between current depth and memory depth is calculated to represent geometry inconsistencies. In addition, the RGB difference is calculated to quantify photometric inconsistency. The difference calculations are straightforward subtractions, where both the depth map and RGB image are patchified using a 4×4 patch grid to enhance robustness. The dot product of the depth and RGB differences is computed in a patch-wise manner and patches with a difference score higher than a predefined threshold are selected.

It should be noted that RGB is sensitive to small changes, while depth estimation lacks consistency across views, such that the combination of these metrics provides more accurate results than when used alone. For each selected patch, it is unprojected into world coordinates using its depth, and then the unprojected 3D point is used as the mean u of the initialized Gaussian. The feature c is derived from the average feature value of the patch, while the initial velocity v and acceleration a are set to zero. t₀ is assigned based on the corresponding image frame, and the temporal decay factor t is set to be the time interval between two adjacent image frames.

### Optimization

After initialization, the goal is to adapt the environment field and optimize the object field based on the latest observations. However, in embodiments, the object field may capture parts of the environment, and vice versa. To promote the disentanglement of the two fields, a regularization loss function is introduced, [symbol] =\sqrt{o_{obj}}/sg[f(c_{obj},cₑₙᵥ)], where f is a certain difference measure such as L1 loss, and sg means detaching this term from gradient calculation. This loss penalizes object opacity when the object and environment fields exhibit similar RGB, ensuring that the object field generates Gaussians only where necessary. In addition, a maintenance loss is introduced, [symbol] , which leverages spatial memory to supervise occluded pixels in the environment field, ensuring that regions obscured by emerging objects preserve their structures. Ultimately, Gₑₙᵥ and G_{obj} are optimized by minimizing the following loss function of Equation 1.

$$ℒ = {ℒ}_{reg} + {ℒ}_{maint} + {ℒ}_{render} + {ℒ}_{depth} \qquad Equation 1$$

where [symbol] denotes the RGB and (optionally) feature rendering loss and [symbol] denoted depth smoothness loss. It should be noted that this entire training objective is purely self-supervised.

The system pipeline 200 may be used for a plurality of different downstream tasks. In an embodiment, the system pipeline 200 may be used for 2D object segmentation, effectively masking out transient objects such as vehicles and pedestrians. In an embodiment, the system pipeline 200 may be used for instance-level photorealistic scene editing, which can in turn be used for automated simulation technology in self-driving and robotics. In an embodiment, the system pipeline 200 may be used for composite rendering, which can be used in autonomous driving scenarios.

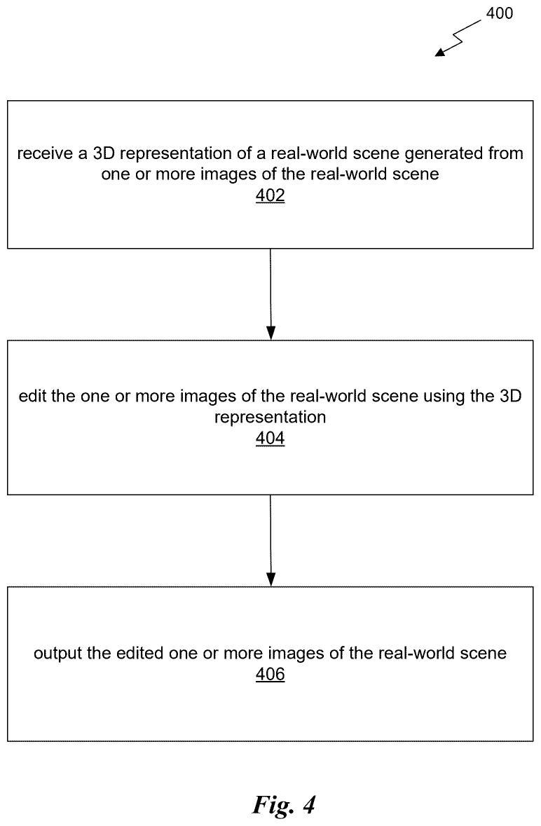

FIG. 4 illustrates a method 400 for using a 3D representation of a real-world scene for scene editing, in accordance with an embodiment. With respect to the present method 400, the 3D representation of the real-world scene is generated via the method 100 of FIG. 1 and/or the system pipeline 200 of FIG. 2. In an embodiment, the method 400 may be performed by an application that, in a processing pipeline, is downstream from the system pipeline 200.

In operation 402, a 3D representation of a real-world scene generated from one or more images of the real-world scene is received. In operation 404, the one or more images of the real-world scene are edited using the 3D representation. In an embodiment, one or more instructions to edit the one or more images may be input via an image editing application or tool. In an embodiment, the instruction(s) may be input by a user. In an embodiment, the instruction(s) may be input as a text command, a mask or other indicator overlaid on the one or more images, or a combination thereof.

Thus, the one or more images of the real-world scene may be edited in accordance with the instruction(s). In an embodiment, the one or more images of the real-world scene may be edited to remove at least one object therefrom. In an embodiment, the one or more images of the real-world scene may be edited to relocate at least one object therein. In an embodiment, the one or more images of the real-world scene may be edited to transport to the one or more images of the real-world scene at least one object from one or more other images of the real-world scene.

In operation 406, the edited one or more images of the real-world scene (resulting from operation 404) is output. In an embodiment, the edited one or more images may be output to a display device. In an embodiment, the edited one or more images may be output to a further downstream application, such as a simulation application used for training an autonomous agent.

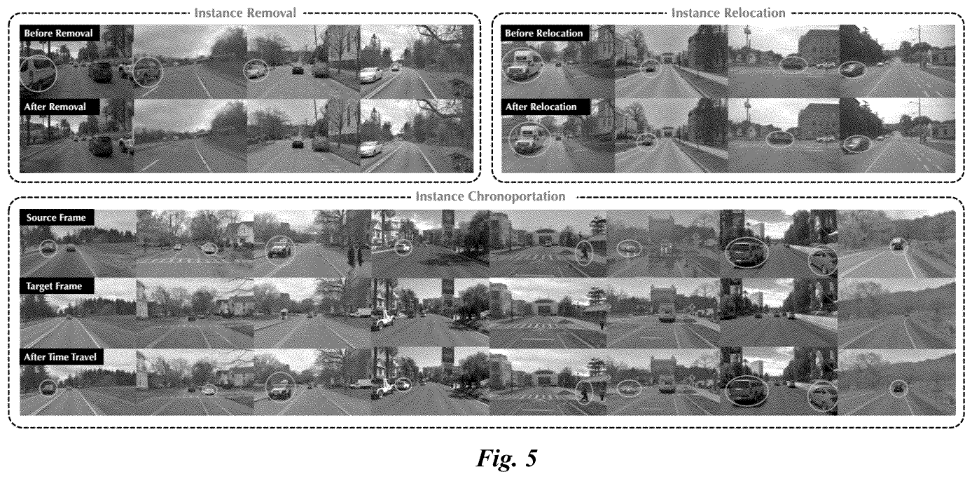

FIG. 5 illustrates exemplary inputs and outputs of the method 400 of FIG. 4, in accordance with an embodiment. For instance removal, the method 400 edits an input plurality of images (top row) to remove a selected object therefrom (bottom row). For object relocation, the method 400 edits an input plurality of images (top row) to relocate a selected object therein (bottom row). For instance chronoportation (i.e. transportation between images), the method 400 transports a selected object from an input plurality of source images (top row) to an input plurality of target images (middle row) to result in the plurality of source images having the object therein (bottom row).

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

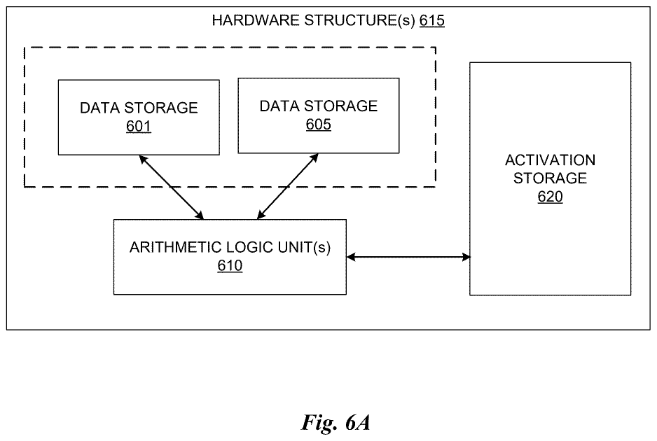

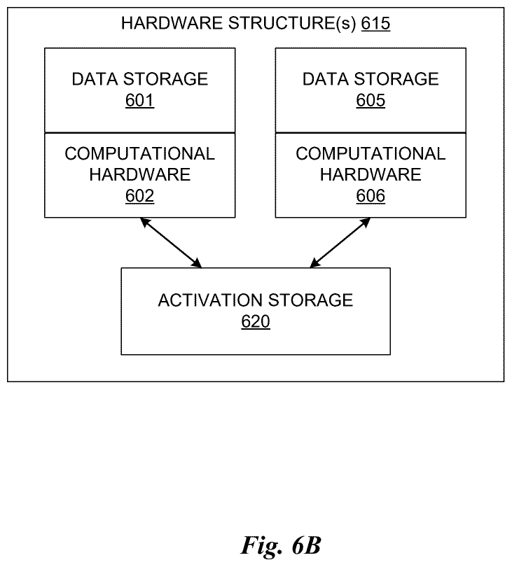

As noted above, a deep learning or neural learning system needs to be trained to generate inferences from input data. Details regarding inference and/or training logic 615 for a deep learning or neural learning system are provided below in conjunction with FIGS. 6A and/or 6B.

In at least one embodiment, inference and/or training logic 615 may include, without limitation, a data storage 601 to store forward and/or output weight and/or input/output data corresponding to neurons or layers of a neural network trained and/or used for inferencing in aspects of one or more embodiments. In at least one embodiment data storage 601 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 601 may be included with other on-chip or off-chip data storage, including a processor's L1, L2, or L3 cache or system memory.

In at least one embodiment, any portion of data storage 601 may be internal or external to one or more processors or other hardware logic devices or circuits. In at least one embodiment, data storage 601 may be cache memory, dynamic randomly addressable memory (“DRAM”), static randomly addressable memory (“SRAM”), non-volatile memory (e.g., Flash memory), or other storage. In at least one embodiment, choice of whether data storage 601 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 615 may include, without limitation, a data storage 605 to store backward and/or output weight and/or input/output data corresponding to neurons or layers of a neural network trained and/or used for inferencing in aspects of one or more embodiments. In at least one embodiment, data storage 605 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 605 may be included with other on-chip or off-chip data storage, including a processor's L1, L2, or L3 cache or system memory. In at least one embodiment, any portion of data storage 605 may be internal or external to on one or more processors or other hardware logic devices or circuits. In at least one embodiment, data storage 605 may be cache memory, DRAM, SRAM, non-volatile memory (e.g., Flash memory), or other storage. In at least one embodiment, choice of whether data storage 605 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 601 and data storage 605 may be separate storage structures. In at least one embodiment, data storage 601 and data storage 605 may be same storage structure. In at least one embodiment, data storage 601 and data storage 605 may be partially same storage structure and partially separate storage structures. In at least one embodiment, any portion of data storage 601 and data storage 605 may be included with other on-chip or off-chip data storage, including a processor's L1, L2, or L3 cache or system memory.

In at least one embodiment, inference and/or training logic 615 may include, without limitation, one or more arithmetic logic unit(s) (“ALU(s)”) 610 to perform logical and/or mathematical operations based, at least in part on, or indicated by, training and/or inference code, result of which may result in activations (e.g., output values from layers or neurons within a neural network) stored in an activation storage 620 that are functions of input/output and/or weight parameter data stored in data storage 601 and/or data storage 605. In at least one embodiment, activations stored in activation storage 620 are generated according to linear algebraic and or matrix-based mathematics performed by ALU(s) 610 in response to performing instructions or other code, wherein weight values stored in data storage 605 and/or data 601 are used as operands along with other values, such as bias values, gradient information, momentum values, or other parameters or hyperparameters, any or all of which may be stored in data storage 605 or data storage 601 or another storage on or off-chip. In at least one embodiment, ALU(s) 610 are included within one or more processors or other hardware logic devices or circuits, whereas in another embodiment, ALU(s) 610 may be external to a processor or other hardware logic device or circuit that uses them (e.g., a co-processor). In at least one embodiment, ALUs 610 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 601, data storage 605, and activation storage 620 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 620 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 620 may be cache memory, DRAM, SRAM, non-volatile memory (e.g., Flash memory), or other storage. In at least one embodiment, activation storage 620 may be completely or partially within or external to one or more processors or other logical circuits. In at least one embodiment, choice of whether activation storage 620 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 615 illustrated in FIG. 6A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 615 illustrated in FIG. 6A may be used in conjunction with central processing unit (“CPU”) hardware, graphics processing unit (“GPU”) hardware or other hardware, such as field programmable gate arrays (“FPGAs”).

FIG. 6B illustrates inference and/or training logic 615, according to at least one embodiment. In at least one embodiment, inference and/or training logic 615 may include, without limitation, hardware logic in which computational resources are dedicated or otherwise exclusively used in conjunction with weight values or other information corresponding to one or more layers of neurons within a neural network. In at least one embodiment, inference and/or training logic 615 illustrated in FIG. 6B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 615 illustrated in FIG. 6B may be used in conjunction with central processing unit (CPU) hardware, graphics processing unit (GPU) hardware or other hardware, such as field programmable gate arrays (FPGAs). In at least one embodiment, inference and/or training logic 615 includes, without limitation, data storage 601 and data storage 605, which may be used to store weight values and/or other information, including bias values, gradient information, momentum values, and/or other parameter or hyperparameter information. In at least one embodiment illustrated in FIG. 6B, each of data storage 601 and data storage 605 is associated with a dedicated computational resource, such as computational hardware 602 and computational hardware 606, respectively. In at least one embodiment, each of computational hardware 606 comprises one or more ALUs that perform mathematical functions, such as linear algebraic functions, only on information stored in data storage 601 and data storage 605, respectively, result of which is stored in activation storage 620.

In at least one embodiment, each of data storage 601 and 605 and corresponding computational hardware 602 and 606, respectively, correspond to different layers of a neural network, such that resulting activation from one “storage/computational pair 601/602” of data storage 601 and computational hardware 602 is provided as an input to next “storage/computational pair 605/606” of data storage 605 and computational hardware 606, in order to mirror conceptual organization of a neural network. In at least one embodiment, each of storage/computational pairs 601/602 and 605/606 may correspond to more than one neural network layer. In at least one embodiment, additional storage/computation pairs (not shown) subsequent to or in parallel with storage computation pairs 601/602 and 605/606 may be included in inference and/or training logic 615.

### Neural Network Training and Deployment

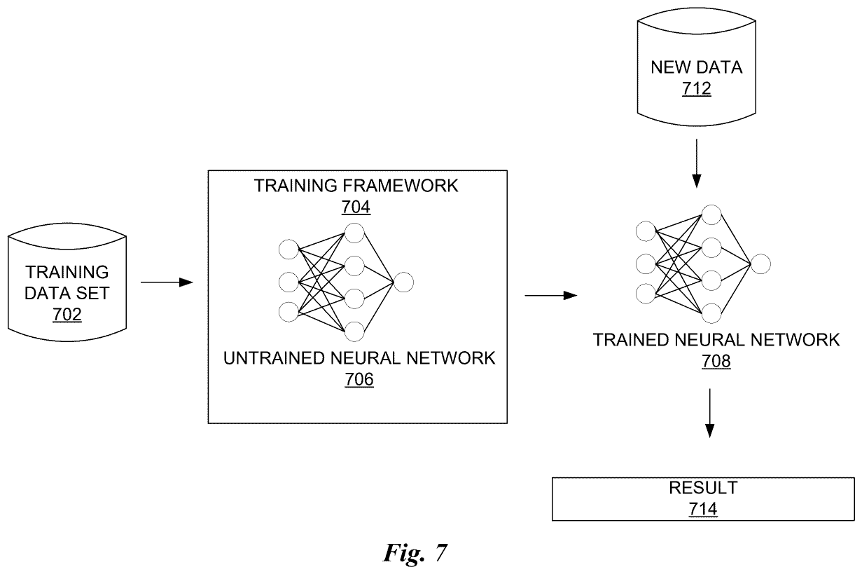

FIG. 7 illustrates another embodiment for training and deployment of a deep neural network. In at least one embodiment, untrained neural network 706 is trained using a training dataset 702. In at least one embodiment, training framework 704 is a PyTorch framework, whereas in other embodiments, training framework 704 is a Tensorflow, Boost, Caffe, Microsoft Cognitive Toolkit/CNTK, MXNet, Chainer, Keras, Deeplearning4j, or other training framework. In at least one embodiment training framework 704 trains an untrained neural network 706 and enables it to be trained using processing resources described herein to generate a trained neural network 708. In at least one embodiment, weights may be chosen randomly or by pre-training using a deep belief network. In at least one embodiment, training may be performed in either a supervised, partially supervised, or unsupervised manner.

In at least one embodiment, untrained neural network 706 is trained using supervised learning, wherein training dataset 702 includes an input paired with a desired output for an input, or where training dataset 702 includes input having known output and the output of the neural network is manually graded. In at least one embodiment, untrained neural network 706 is trained in a supervised manner processes inputs from training dataset 702 and compares resulting outputs against a set of expected or desired outputs. In at least one embodiment, errors are then propagated back through untrained neural network 706. In at least one embodiment, training framework 704 adjusts weights that control untrained neural network 706. In at least one embodiment, training framework 704 includes tools to monitor how well untrained neural network 706 is converging towards a model, such as trained neural network 708, suitable to generating correct answers, such as in result 714, based on known input data, such as new data 712. In at least one embodiment, training framework 704 trains untrained neural network 706 repeatedly while adjust weights to refine an output of untrained neural network 706 using a loss function and adjustment algorithm, such as stochastic gradient descent. In at least one embodiment, training framework 704 trains untrained neural network 706 until untrained neural network 706 achieves a desired accuracy. In at least one embodiment, trained neural network 708 can then be deployed to implement any number of machine learning operations.

In at least one embodiment, untrained neural network 706 is trained using unsupervised learning, wherein untrained neural network 706 attempts to train itself using unlabeled data. In at least one embodiment, unsupervised learning training dataset 702 will include input data without any associated output data or “ground truth” data. In at least one embodiment, untrained neural network 706 can learn groupings within training dataset 702 and can determine how individual inputs are related to untrained dataset 702. In at least one embodiment, unsupervised training can be used to generate a self-organizing map, which is a type of trained neural network 708 capable of performing operations useful in reducing dimensionality of new data 712. In at least one embodiment, unsupervised training can also be used to perform anomaly detection, which allows identification of data points in a new dataset 712 that deviate from normal patterns of new dataset 712.

In at least one embodiment, semi-supervised learning may be used, which is a technique in which in training dataset 702 includes a mix of labeled and unlabeled data. In at least one embodiment, training framework 704 may be used to perform incremental learning, such as through transferred learning techniques. In at least one embodiment, incremental learning enables trained neural network 708 to adapt to new data 712 without forgetting knowledge instilled within network during initial training.

### Data Center

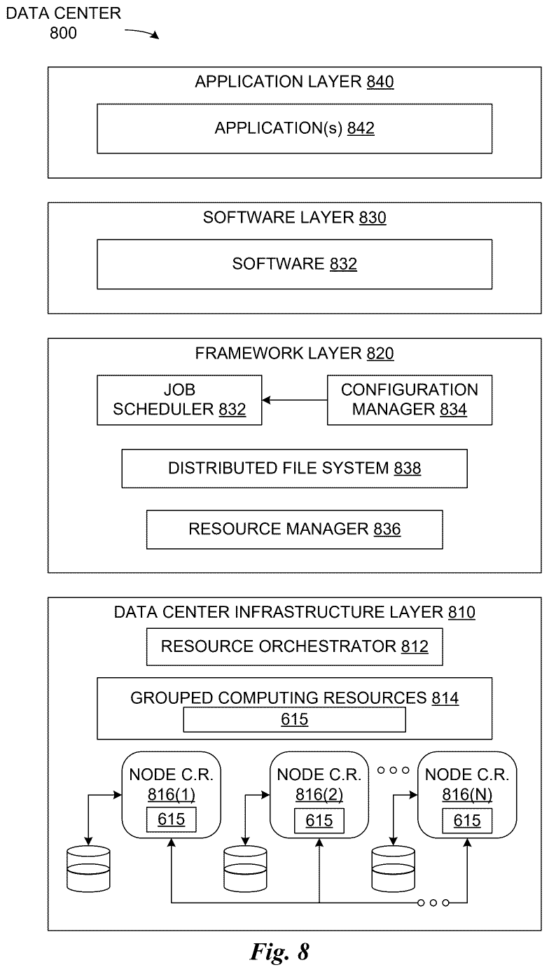

FIG. 8 illustrates an example data center 800, in which at least one embodiment may be used. In at least one embodiment, data center 800 includes a data center infrastructure layer 810, a framework layer 820, a software layer 830 and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 822 may configure or otherwise control one or more node C.R.s 816(1)-816(N) and/or grouped computing resources 814. In at least one embodiment, resource orchestrator 822 may include a software design infrastructure (“SDI”) management entity for data center 800. In at least one embodiment, resource orchestrator may include hardware, software or some combination thereof.

In at least one embodiment, as shown in FIG. 8, framework layer 820 includes a job scheduler 832, a configuration manager 834, a resource manager 836 and a distributed file system 838. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may utilize distributed file system 838 for large-scale data processing (e.g., “big data”). In at least one embodiment, job scheduler 832 may include a Spark driver to facilitate scheduling of workloads supported by various layers of data center 800. In at least one embodiment, configuration manager 834 may be capable of configuring different layers such as software layer 830 and framework layer 820 including Spark and distributed file system 838 for supporting large-scale data processing. In at least one embodiment, resource manager 836 may be capable of managing clustered or grouped computing resources mapped to or allocated for support of distributed file system 838 and job scheduler 832. In at least one embodiment, clustered or grouped computing resources may include grouped computing resource 814 at data center infrastructure layer 810. In at least one embodiment, resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underutilized and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 615 are used to perform inferencing and/or training operations associated with one or more embodiments. In at least one embodiment, inference and/or training logic 615 may be used in system FIG. 8 for inferencing or predicting operations based, at least in part, on weight parameters calculated using neural network training operations, neural network functions and/or architectures, or neural network use cases described herein.

As described herein with reference to FIGS. 1-5, a method, computer readable medium, and system are disclosed for using a diffusion model to generate a 2D image of a scene from a scene representation comprised of 3D blobs. The diffusion model may be stored (partially or wholly) in one or both of data storage 601 and 605 in inference and/or training logic 615 as depicted in FIGS. 6A and 6B. Training and deployment of the diffusion model may be performed as depicted in FIG. 7 and described herein. Distribution of the diffusion model may be performed using one or more servers in a data center 800 as depicted in FIG. 8 and described herein.

What is claimed is:

1. A method, comprising:
at a device:
generating a three-dimensional (3D) representation of a real-world scene from:
at least one first image capturing the real-world scene at a first point in time, and
a representation of time-invariant components of the real-world scene generated from one or more second images capturing the real-world scene at one or more second points in time that occurred earlier than the first point in time;
editing the at least one first image using the 3D representation of the real-world scene to form at least one edited image, the editing including at least one of:
removing at least one object in the at least one first image of the real-world scene,
relocating at least one object in the at least one first image of the real-world scene, or
transporting at least one object from the one or more second images to the at least one first image of the real-world scene; and
outputting the at least one edited image.

2. The method of claim 1, wherein the representation of the time-invariant components of the real-world scene includes 3D Gaussians of the time-invariant components of the real-world scene.

3. The method of claim 1, further comprising, at the device:
detecting, from the at least one first image, the transient components of the real-world scene at the first point in time; and
generating a representation of the transient components of the real-world scene at the first point in time;
wherein the 3D representation of the real-world scene at the first point in time is further generated based on the representation of the transient components of the real-world scene.

4. The method of claim 3, further comprising, at the device:
optimizing the representation of the transient components of the real-world scene and the representation of the time-invariant components of the real-world scene by minimizing at least one loss function.

5. The method of claim 4, wherein the at least one loss function is at least one of:
a regularization loss function that promotes disentanglement of the representation of the transient components of the real-world scene and the representation of the time-invariant components of the real-world scene,
a maintenance loss function that supervises occluded pixels in the representation of the time-invariant components of the real-world scene to preserve the structure of one or more of the time-invariant components that are obscured by one or more of the transient components,
a rendering loss function, or
a depth smoothness loss function.

6. The method of claim 4, wherein the 3D representation of the real-world scene is comprised of the optimized representation of the transient components of the real-world scene and the optimized representation of the time-invariant components of the real-world scene.

7. A method, comprising:
at a device:
accessing at least one first image capturing a real-world scene at a first point in time;
accessing a representation of time-invariant components of the real-world scene generated from one or more second images capturing the real-world scene at one or more second points in time that occurred earlier than the first point in time;
generating a three-dimensional (3D) representation of the real-world scene at the first point in time using the at least one first image and the representation of the time-invariant components of the real-world scene.

8. The method of claim 7, wherein the at least one first image includes at least one frame of a video capturing the real-world scene at the first point in time.

9. The method of claim 7, wherein the at least one first image is generated by a camera installed on an autonomous driving vehicle traversing the real-world scene.

10. The method of claim 7, wherein the one or more second images include one or more second frames of one or more videos capturing the real-world scene at the one or more second points in time that occurred earlier than the first point in time.

11. The method of claim 7, wherein the time-invariant components of the real-world scene include static objects in the real-world scene.

12. The method of claim 7, wherein a spatial memory includes the representation of the time-invariant components of the real-world scene.

13. The method of claim 7, wherein the representation of the time-invariant components of the real-world scene includes 3D Gaussians of the time-invariant components of the real-world scene.

14. The method of claim 13, wherein the 3D Gaussians are learned using 3D Gaussian Splatting (3DGS).

15. The method of claim 7, wherein the representation of the time-invariant components of the real-world scene excludes transient components of the real-world scene.

16. The method of claim 7, further comprising, at the device:
detecting, from the at least one first image, the transient components of the real-world scene at the first point in time; and
generating a representation of the transient components of the real-world scene at the first point in time;
wherein the 3D representation of the real-world scene at the first point in time is further generated based on the representation of the transient components of the real-world scene.

17. The method of claim 16, wherein the transient components of the real-world scene at the first point in time are detected based on:
a depth difference between the at least one first image and the representation of the time-invariant components of the real-world scene, and
a color difference between the at least one first image and the representation of the time-invariant components of the real-world scene.

18. The method of claim 16, wherein the representation of the transient components of the real-world scene includes 4D Gaussians of the transient components of the real-world scene.

19. The method of claim 16, further comprising, at the device:
optimizing the representation of the transient components of the real-world scene and the representation of the time-invariant components of the real-world scene by minimizing at least one loss function.

20. The method of claim 19, wherein the at least one loss function is a regularization loss function that promotes disentanglement of the representation of the transient components of the real-world scene and the representation of the time-invariant components of the real-world scene.

21. The method of claim 19, wherein the at least one loss function is a maintenance loss function that supervises occluded pixels in the representation of the time-invariant components of the real-world scene to preserve the structure of one or more of the time-invariant components that are obscured by one or more of the transient components.

22. The method of claim 19, wherein the at least one loss function is a rendering loss function.

23. The method of claim 19, wherein the at least one loss function is a depth smoothness loss function.

24. The method of claim 19, wherein the 3D representation of the real-world scene is comprised of the optimized representation of the transient components of the real-world scene and the optimized representation of the time-invariant components of the real-world scene.

25. The method of claim 7, further comprising, at the device:
outputting the 3D representation of the real-world scene to a downstream task.

26. The method of claim 25, wherein the downstream task uses the 3D representation of the real-world scene to perform image synthesis including at least one of:
removing at least one object in the at least one first image of the real-world scene,
relocating at least one object in the at least one first image of the real-world scene, or
transporting at least one object from the one or more second images to the at least one first image of the real-world scene.

27. A system, comprising:
a non-transitory memory storage comprising instructions; and
one or more processors in communication with the memory, wherein the one or more processors execute the instructions to:
access at least one first image capturing a real-world scene at a first point in time;
access a representation of time-invariant components of the real-world scene generated from one or more second images capturing the real-world scene at one or more second points in time that occurred earlier than the first point in time; and
generate a three-dimensional (3D) representation of the real-world scene at the first point in time using the at least one first image and the representation of the time-invariant components of the real-world scene.

28. A non-transitory computer-readable media storing computer instructions which when executed by one or more processors of a device cause the device to:
access at least one first image capturing a real-world scene at a first point in time;
access a representation of time-invariant components of the real-world scene generated from one or more second images capturing the real-world scene at one or more second points in time that occurred earlier than the first point in time; and
generate a three-dimensional (3D) representation of the real-world scene at the first point in time using the at least one first image and the representation of the time-invariant components of the real-world scene.
